(19) United States
(12) Patent Application Publication
(10) Pub. No.: US 2026/0089650 A1
(43) Pub. Date: Mar. 26, 2026

(54) USER EQUIPMENT TRANSMISSION POWER CONTROL WITH TARGET SURVIVAL TIME

(71) Applicant: Apple Inc., Cupertino, CA (US)

(72) Inventors: Lorenzo Bertizzolo, San Francisco, CA (US); Prashant H. Vashi, San Jose, CA (US)

(73) Assignee: Apple Inc., Cupertino, CA (US)

(21) Appl. No.: 19/327,949

(22) Filed: Sep. 12, 2025

Related U.S. Application Data
(60) Provisional application No. 63/699,072, filed on Sep. 25, 2024.

(51) Int. Cl. H04W 52/36; H04W 52/22; H04W 76/20

(52) U.S. Cl. CPC H04W 52/367; H04W 52/225; H04W 76/20

(57) ABSTRACT

The present application relates to devices and components including apparatuses, systems, and methods for user equipment transmission power control based on a target survival time. The power control scheme may comply with a specific absorption rate (SAR) requirement. For example, the UE may determine the target survival time for a communication session, e.g., based on context information associated with the communication session such as an application, a type of application, and/or an expected uplink connection duration associated with the communication session. The UE may determine a value of the transmission power based on the target survival time, e.g., to ensure that the UE can maintain the value of the transmission power for at least the target survival time while also complying with the SAR requirement.

### CROSS-REFERENCE TO RELATED APPLICATION

This application claims the benefit of U.S. Provisional Patent Application No. 63/699,072, filed on Sep. 25, 2024, which is herein incorporated by reference in its entirety for all purposes.

### TECHNICAL FIELD

This application relates generally to communication networks and, in particular, to user equipment transmission power control with target survival time.

### BRIEF DESCRIPTION OF THE DRAWINGS

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

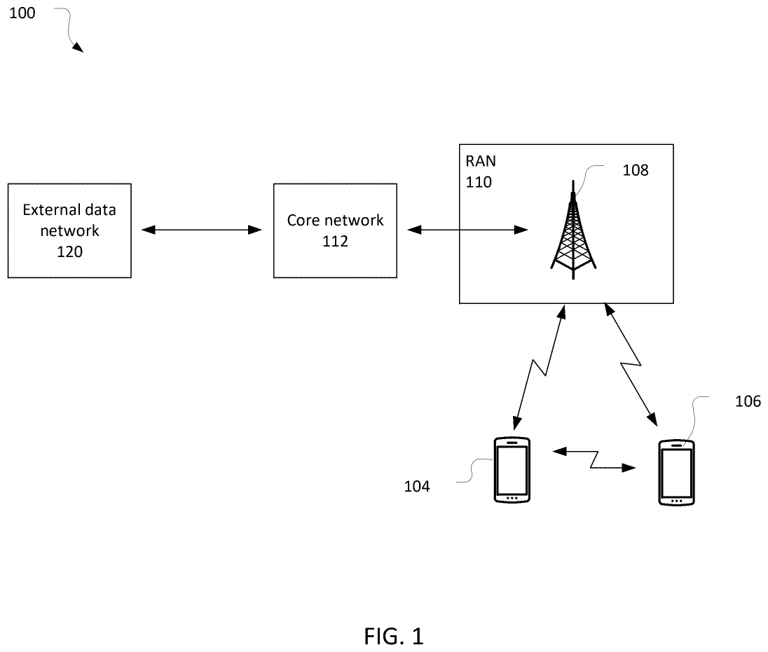

FIG. 1 illustrates a network environment in accordance with some embodiments.

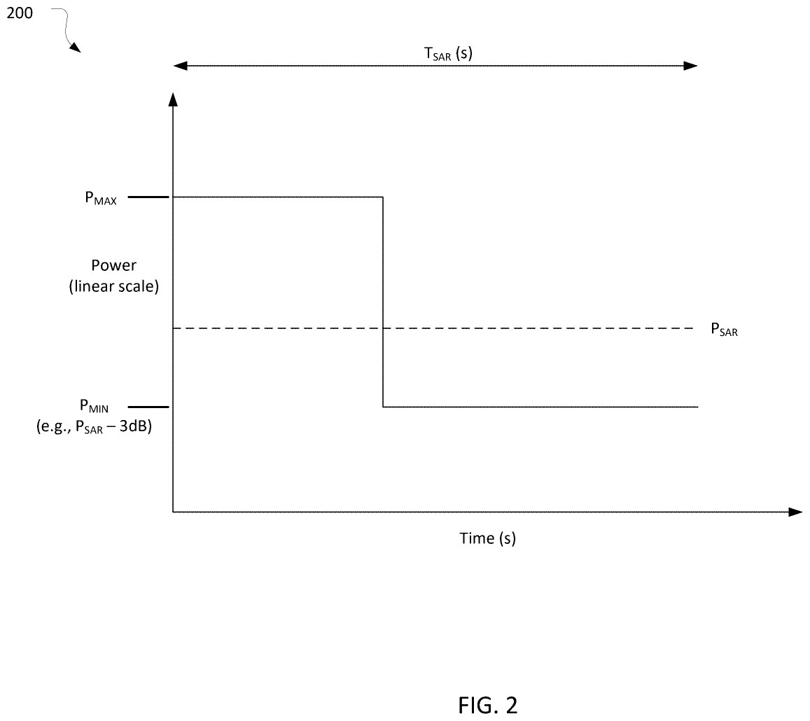

FIG. 2 illustrates an example of transmission power control over a time period.

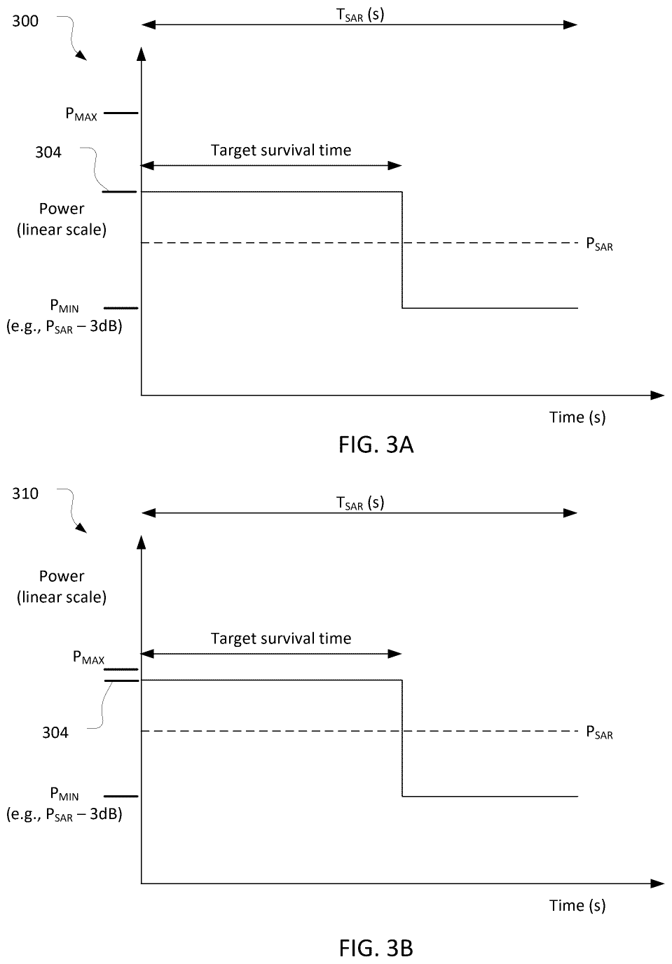

FIG. 3A illustrates another example of transmission power control over a time period, in accordance with some embodiments.

FIG. 3B illustrates another example of transmission power control over a time period, in accordance with some embodiments.

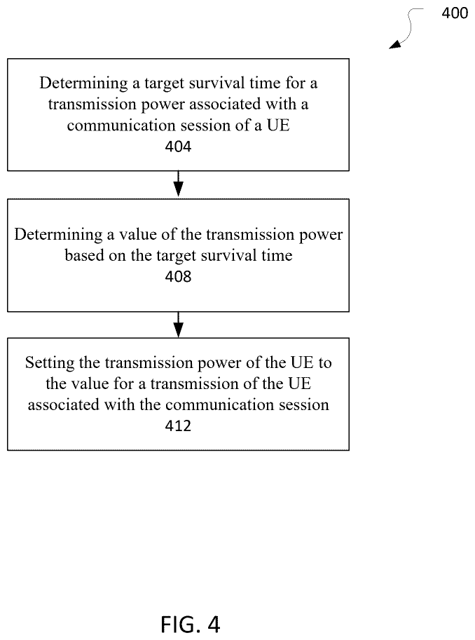

FIG. 4 illustrates an operational flow/algorithmic structure in accordance with some embodiments.

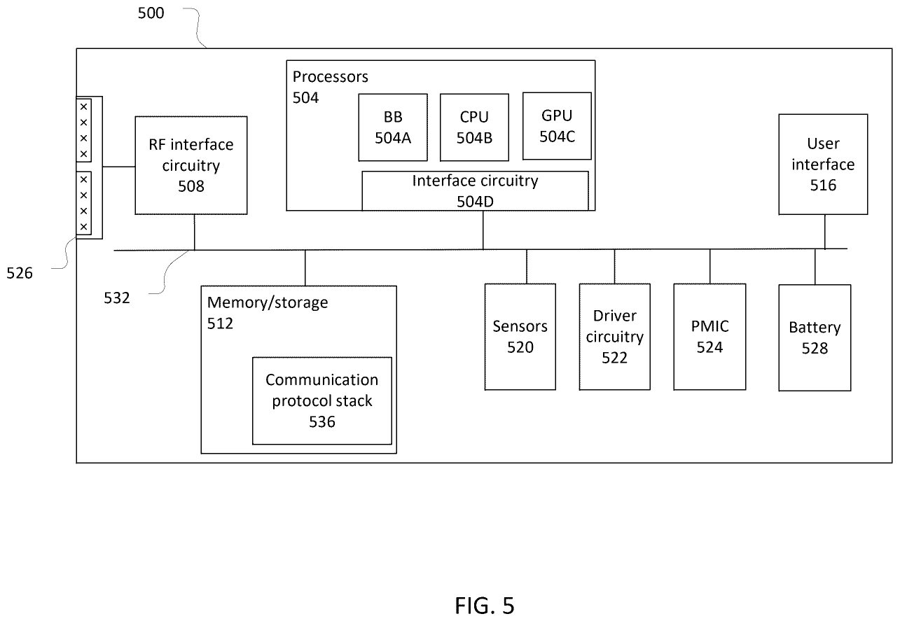

FIG. 5 illustrates a user equipment in accordance with some embodiments.

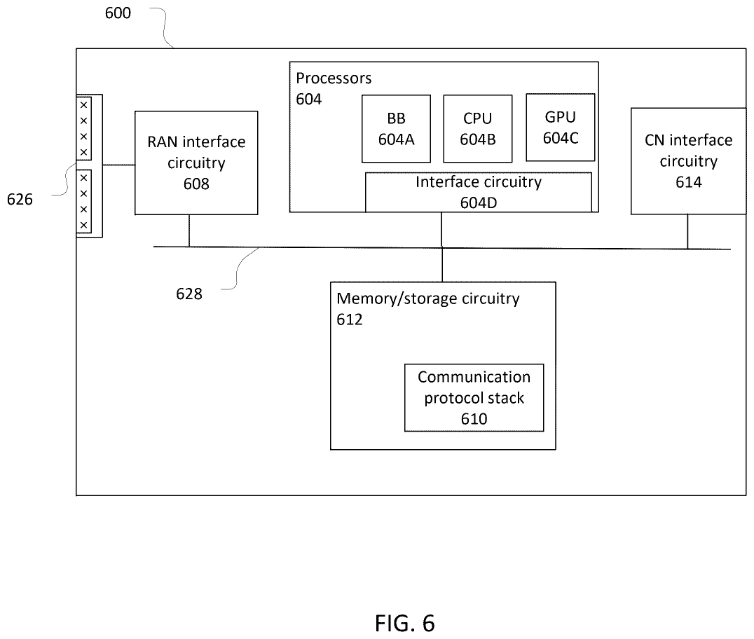

FIG. 6 illustrates a network device in accordance with some embodiments.

### DETAILED DESCRIPTION

Various embodiments herein provide a transmission power control scheme to control a transmission power of a user equipment based on a target survival time while also complying with a specific absorption rate (SAR) requirement. For example, the UE may determine the target survival time for a communication session, e.g., based on context information associated with the communication session such as an application, a type of application, and/or an expected uplink connection duration associated with the communication session. The UE may determine a value of the transmission power (e.g., instantaneous transmission power) based on the target survival time, e.g., to ensure that the UE can maintain the value of the transmission power for at least the target survival time (while also complying with the SAR requirement). In some circumstances, the UE may reduce the transmission power after the target survival time to comply with the SAR requirement.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

The network environment 100 may further include an external data network 120. The external data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

Operations described herein as performed by a device (for example, UE 104, base station 108, and/or a device of core network 112) may be fully, substantially, or partially performed by processing circuitry implemented on the device. Additionally, operations described herein as performed by “the network” may be performed by a device of the RAN 110 (e.g., base station 108), a device of the core network 112, and/or components thereof.

The UE 104 may perform power control to control a transmission (Tx) power of the UE 104 (e.g., for uplink transmissions and/or sidelink transmissions). The power control may be in accordance with specific absorption rate (SAR) compliance regulations. According to SAR compliance regulations, the Tx power of a wireless device must have no more than a specified average power P_{SAR} (e.g., in Watts) over a SAR window of T_{SAR} (e.g., in seconds). The regulations may be different for different regions and/or use cases.

The power control may be further subject to a maximum instantaneous power P_{MAX} which may be determined by the regulations and/or hardware capability. In an example, the modem firmware of the UE can set the instantaneous power P to any value lower than or equal to P_{MAX} as long as it complies with averaging less than P_{SAR} over any time window T_{SAR}.

Different power control techniques may be used to allocate the transmission power. In one implementation, the instantaneous power P is set equal to P_{MAX} for as long as it is sustainable, while also guaranteeing a minimum instantaneous power P_{MIN} equal to P_{SAR}-3 dB. FIG. 2 illustrates an example plot 200 of transmission power over the time period T_{SAR}. When the UL duty cycle (e.g., the percentage of time the UE is transmitting) is relatively high, the device runs out of power budget fast and falls to P_{MIN} quickly. The amount of time that the Tx power is at the higher power level is referred to as the survival time.

The Tx power of the UE may impact performance. Generally, the uplink device performance is worse when the Tx power is lower (e.g., P_{MIN}) and is better when the Tx power is higher (e.g., P_{MAX}).

Various embodiments herein provide techniques to control Tx power of a UE based on a target survival time for SAR averaging. For example, the UE may determine a target survival time for a communication session, e.g., based on context information associated with the communication session such as an application, a type of application, and/or an expected uplink connection duration associated with the communication session. The UE may determine a value of the transmission power (e.g., instantaneous transmission power) based on the target survival time, e.g., to ensure that the UE can maintain the value of the transmission power for at least the target survival time (while also complying with the SAR requirement).

The device survival time (e.g., the time spent at a higher power level before falling to P_{MIN}) depends on the gap between the set power P and P_{MIN}. Given P, P_{SAR}, T_{SAR}, and the uplink duty cycle (ULDC), the survival time (Tₛᵤᵥᵢᵥₐₗ) can be calculated starting from the SAR compliance equation as shown below:

$$P \cdot ULDC \cdot {T}_{survival} + {P}_{MIN} \cdot ULDC \cdot ( {T}_{SAR} - {T}_{survival} ) = {T}_{SAR} \cdot {P}_{SAR}$$

$${T}_{survival} = \frac{( {T}_{SAR} \cdot {P}_{SAR} - {P}_{MIN} \cdot {T}_{SAR} \cdot ULDC )}{( P \cdot ULDC - {P}_{MIN} \cdot ULDC )}$$

Given an uplink duty cycle, when the P-P_{MIN} gap is high (e.g., many dBs) the survival time is relatively short and the device will fall to P_{MIN} relatively fast (e.g., compared to T_{SAR}). When the P-P_{MIN} gap is low (e.g., few dBs), the survival time is relatively long and the device will fall to P_{MIN} after a longer period of time.

Note that the values of P_{MAX} and P_{SAR} may be different for different cellular configurations (e.g., corresponding to radio access technology (RAT), frequency band, antenna port, and/or positioning of the UE relative to the head and/or body of a user, etc.). Accordingly, the same power allocation scheme may lead to significantly different survival times (and thus different uplink performance) for different cellular configurations.

In various embodiments, the instantaneous Tx power P may be determined and/or set to provide a survival time equal to at least the target survival time. The target survival time may be determined dynamically based on context information associated with a communication session, such as an application that is in use, a type of application that is in use, an estimated duration of a radio resource control (RRC) connection, an expected ULDC, etc. In an example, the context information and/or the target survival time may be based on historical data (e.g., associated with the same use case and/or a similar use case). In one example, the target survival time may be set at the median of an uplink connection duration (e.g., based on the duration of RRC connection and/or the ULDC for respective uses) for a given application. For example, the uplink connection duration may correspond to the duration of the RRC connection multiplied by the ULDC. In some embodiments, the historical data may additionally or alternatively indicate location information, UE mobility information, time of day, day of the week, and/or other information associated with prior uses of the same application and/or a different application. The historical data may be associated with the UE, the user (e.g., on the UE and/or another device that interacts with the user), and/or other users.

In some embodiments, an artificial intelligence (AI)/machine learning (ML) model may be used to generate one or more estimates (e.g., inferences) that are used to determine the target survival time (such as ULDC, RRC connection duration, and/or uplink connection duration) and/or to directly estimate the target survival time. For example, the AI/ML model may be trained with historical data associated with the UE, the user, and/or other UEs/users. As discussed above, the historical data may indicate application information (e.g., application ID and/or type of application), RRC connection duration, ULDC, uplink connection duration, location information of the UE, UE mobility information, time of day, day of the week, and/or other information associated with prior uses of the same application and/or different applications. The prior uses may be associated with the UE, the user, and/or other users.

In some embodiments, a plurality of candidate survival times may be determined at a given time. One of the candidate survival times may be selected as the target survival time. For example, the target survival time may be selected from among the candidate survival times based on one or more factors, such as a user setting, application information (e.g., application ID, type of application, etc.), location information, time of day and/or day of the week, user positioning information (e.g., a proximity of the user to the UE, an orientation of the UE with respect to the user, etc.), and/or other information.

The power control techniques described herein may provide several benefits. For example, the power control techniques may provide improved power budget exhaustion. The device may burn through its power budget in a target amount of time that may be dynamically adjusted (e.g., optimized) based on the use case. Accordingly, the device makes use of most of the available SAR power budget in the target survival time. This may maximize the uplink performance for the length of the target survival time. Additionally, the power control techniques may provide protection against a quick reduction of the Tx power to P_{MIN}. For example, the power control techniques may ensure that the device does not use all of the SAR power budget and thus reduce the Tx power to P_{MIN} prior to the target survival time. Accordingly, the techniques may avoid poor uplink performance due to low Tx power during the target survival time.

The power control techniques may additionally or alternatively provide consistency of SAR budget utilization across different cellular configurations. The cellular configuration may include, for example, the RAT (e.g., 4G/LTE, 5G/NR, 6G, etc.), frequency band (e.g., 3GPP Frequency Range 1 (FR1), Frequency Range 2 (FR2), and/or the specific frequency band(s) within FR1 and/or FR2), antenna port, positioning of the UE relative to the head and/or body of a user, and/or other information. In an example, the power control scheme may account for different power limits (e.g., P_{MAX}, P_{SAR}) that are applicable with different cellular configurations. Accordingly, the power control scheme may provide a higher transmission power (and thus improved performance) for at least the target survival time independent of the cellular configuration.

In one example in accordance with embodiments herein, the instantaneous power P may be set based on the target survival time according to:

$$P = \frac{( {T}_{SAR} \cdot {P}_{SAR} - ULDC \cdot {P}_{MIN} \cdot ( {T}_{SAR} - {T}_{survival} ) )}{( ULDC \cdot {T}_{survival} )}$$

In embodiments in which the instantaneous power is capped at P_{MAX} (e.g., based on regulation and/or hardware limitations), the instantaneous power may be set according to:

$$P = min ( {P}_{MAX} , \frac{( {T}_{SAR} \cdot {P}_{SAR} - ULDC \cdot {P}_{MIN} \cdot ( {T}_{SAR} - {T}_{survival} ) )}{( ULDC \cdot {T}_{survival} )} )$$

FIGS. 3A and 3B illustrate example plots 300 and 310, respectively, of Tx power over time with a same target survival time and with different cellular configuration. For example, FIG. 3A illustrates the Tx power with a relatively large P_{MAX}-P_{SAR} gap, and FIG. 3B illustrates the Tx power with a relatively small P_{MAX}-P_{SAR} gap. The instantaneous Tx power may be set at a first value 304 for the duration of the survival time (also referred to as a first phase of the power control scheme) before dropping to P_{MIN} (e.g., for the remainder of T_{SAR}). The first value may be greater than P_{SAR} and less than or equal to P_{MAX}.

The power control scheme may be implemented in a UE via any suitable mechanism. For example, the power control scheme may be implemented in firmware and/or via a power cap application programming interface (API) implementation (e.g., maximum transmit power level (MTPL) API). Aspects of the power control scheme may be implemented in the baseband processor of the UE and/or in radio frequency (RF) circuitry of the UE (e.g., modem circuitry).

Some example simulation results are described further below.

In a first example scenario, the Tₛᵤᵣᵥᵢᵥₐₗ=50 seconds (s), P_{MAX}=25 dBm, P_{SAR}=21 dBm, and T_{SAR}=100s. Table 1 below illustrates the instantaneous power (P) for the first phase of the power control scheme, the associated survival time (the time for which the power can be maintained at the higher power of the first phase), the P_{MIN}, and the associated P_{MIN} time for various ULDC values from 10% to 100%.

TABLE 1

| ULDC | P | P_{MIN} | Survival time | P_{MIN} time |
|---|---|---|---|---|
| 10 | 25.00 | 25.00 | 100 | 0 |
| 20 | 25.00 | 24.99 | 100 | 0 |
| 30 | 25.00 | 23.23 | 100 | 0 |
| 40 | 25.00 | 21.98 | 99 | 1 |
| 50 | 25.00 | 21.01 | 66 | 34 |
| 60 | 24.98 | 20.22 | 50 | 50 |
| 70 | 24.31 | 19.55 | 50 | 50 |
| 80 | 23.73 | 18.97 | 50 | 50 |
| 90 | 23.22 | 18.46 | 50 | 50 |
| 100 | 22.76 | 18.00 | 50 | 50 |

The control scheme may ensure that the survival time is always at least the target survival time unless limited by the maximum transmission power P_{MAX}. Accordingly, the control scheme may maximize the transmission power for the duration of the target survival time and guarantee that the transmission power does not fall to P_{MIN} within the target survival time.

In a second example scenario, the Tₛᵤᵣᵥᵢᵥₐₗ=50s, P_{MAX}=23.5 dBm, P_{SAR}=12.8 dBm, and T_{SAR}=100s. Accordingly, the second example scenario has a wider P_{MAX}-P_{SAR} gap than the first example scenario.

For the second example scenario, Table 2 below illustrates the instantaneous power (P) for the first phase of the power control scheme, the associated survival time, the P_{MIN}, and the associated P_{MIN} time for various ULDC values from 10% to 100%.

TABLE 2

| ULDC | P | P_{MIN} | Survival time | P_{MIN} time |
|---|---|---|---|---|
| 10 | 23.50 | 19.80 | 74 | 26 |
| 20 | 21.55 | 16.79 | 50 | 50 |
| 30 | 19.79 | 15.03 | 50 | 50 |
| 40 | 18.54 | 13.78 | 50 | 50 |
| 50 | 17.57 | 12.81 | 50 | 50 |
| 60 | 16.78 | 12.02 | 50 | 50 |
| 70 | 16.11 | 11.35 | 50 | 50 |
| 80 | 15.53 | 10.77 | 50 | 50 |
| 90 | 15.02 | 10.26 | 50 | 50 |
| 100 | 14.56 | 9.80 | 50 | 50 |

As with the first scenario, the control scheme may ensure that the survival time is always at least the target survival time unless limited by the maximum transmission power P_{MAX}. Accordingly, the control scheme may maximize the transmission power for the duration of the target survival time and guarantee that the transmission power does not fall to P_{MIN} within the target survival time.

With the wider P_{MAX}-P_{SAR} gap of the second scenario compared with the first scenario, the survival time is limited to the target survival time at lower ULDC (e.g., 20% and higher ULDC in Table 2 compared to 60% and higher ULDC in Table 1).

FIG. 4 illustrates an operational flow/algorithmic structure 400 in accordance with some embodiments. The operational flow/algorithmic structure 400 may be performed by a UE (e.g., UE 104 and/or UE 500) and/or components thereof (e.g., processor circuitry such as one or more of processors 504).

In an example, the operational flow/algorithmic structure 400 includes, at 404, determining a target survival time for a transmission power associated with a communication session of a UE. In an example, the target survival time may be determined based on an expected uplink connection duration associated with the communication session. For example, the expected uplink duration may be determined based on an estimated duration of an RRC connection and/or an estimated ULDC associated with the communication session. In an example, the expected uplink duration and/or the target survival time may be determined based on context information associated with the communication session. The context information may include, for example, an application associated with the communication session, a type of application associated with the communication session, location information that indicates a location of the UE, mobility information of the UE, a time of day, a day of the week, and/or other information. In some embodiments, the expected uplink duration and/or the target survival time may be determined based on historical data associated with the application or the type of application. The historical data may be associated with the UE, a user of the UE, and/or at least one other UE. In an example, the target survival time may be selected from among a plurality of candidate survival times.

The operational flow/algorithmic structure 400 may further include, at 408, determining a value of the transmission power based on the target survival time. In an example, the value of the transmission power may be determined further based on one or more of an SAR time window (e.g., T_{SAR}), an average power requirement over the SAR time window (e.g., P_{SAR}), an uplink duty cycle (ULDC), a guaranteed minimum transmission power (e.g., P_{MIN}), or a maximum transmission power (e.g., P_{MAX}).

The operational flow/algorithmic structure 400 may further include, at 412, setting the transmission power of the UE to the value for a transmission of the UE associated with the communication session. In an example, the UE may transmit the transmission (e.g., an uplink or sidelink transmission) with the transmission power. In some instances, the UE may reduce the transmission power after expiration of the target survival time to comply with an SAR requirement.

For example, the UE may set the transmission power to a first value that is based on the target survival time associated with the communication session. The UE may reduce the transmission power to a second value after expiration of the target survival time.

In another example, processor circuitry of the UE (e.g., processor circuitry 504 of UE 500, discussed below) may generate data associated with the communication session. An RF transmitter of the UE (e.g., RF interface circuitry 508 and/or antenna 526 of the UE 500) may transmit the data with a first power level that is based on the target survival time associated with the communication session. The RF transmitter may further transmit the data with a second power level after expiration of the target survival time. The second power level may be less than the first power level.

FIG. 5 illustrates a UE 500 in accordance with some embodiments. The UE 500 may be similar to and substantially interchangeable with UE 104 or 106. For example, the UE 500 may implement a transmission power control scheme based on a target survival time as described herein.

The UE 500 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 500 may include processors 504, RF interface circuitry 508, memory/storage 512, user interface 516, sensors 520, driver circuitry 522, power management integrated circuit (PMIC) 524, antenna 526, and battery 528. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 532, which may represent any type of interface, input/output, bus (local, system, or expansion), transmission line, trace, or optical connection that allows various circuit components (on common or different chips or chipsets) to interact with one another.

The processors 504 may include processor circuitry such as, for example, baseband processor circuitry (BB) 504A, central processor unit circuitry (CPU) 504B, and graphics processor unit circuitry (GPU) 504C. The processors 504 may include any type of circuitry or processor circuitry that executes or otherwise operates computer-executable instructions, such as program code, software modules, or functional processes from memory/storage 512 to cause the UE 500 to perform transmission power control as described herein. The processors 504 may also include interface circuitry 504D to communicatively couple the processor circuitry with one or more other components of the UE 500.

In some embodiments, the baseband processor circuitry 504A may access a communication protocol stack 536 in the memory/storage 512 to communicate over a 3GPP compatible network. In general, the baseband processor circuitry 504A may access the communication protocol stack 536 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 508.

The baseband processor circuitry 504A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 512 may include one or more non-transitory, computer-readable media that includes instructions (for example, communication protocol stack 536) that may be executed by one or more of the processors 504 to cause the UE 500 to perform various transmission power control operations described herein.

The memory/storage 512 includes any type of volatile or non-volatile memory that may be distributed throughout the UE 500. In some embodiments, some of the memory/storage 512 may be located on the processors 504 themselves (for example, memory/storage 512 may be part of a chipset that corresponds to the baseband processor circuitry 504A), while other memory/storage 512 is external to the processors 504 but accessible thereto via a memory interface. The memory/storage 512 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 508 may include transceiver circuitry and a radio frequency front end module (RFFEM) that allows the UE 500 to communicate with other devices over a radio access network. The RF interface circuitry 508 may include various elements arranged in transmit or receive paths. These elements may include, for example, switches, mixers, amplifiers, filters, synthesizer circuitry, and control circuitry.

In the receive path, the RFFEM may receive a radiated signal from an air interface via antenna 526 and proceed to filter and amplify (with a low-noise amplifier) the signal. The signal may be provided to a receiver of the transceiver that down-converts the RF signal into a baseband signal that is provided to the baseband processor of the processors 504.

In the transmit path, the transmitter of the transceiver up-converts the baseband signal received from the baseband processor and provides the RF signal to the RFFEM. The RFFEM may amplify the RF signal through a power amplifier prior to the signal being radiated across the air interface via the antenna 526.

In various embodiments, the RF interface circuitry 508 may be configured to transmit/receive signals in a manner compatible with NR access technologies.

The antenna 526 may include antenna elements to convert electrical signals into radio waves to travel through the air and to convert received radio waves into electrical signals. The antenna elements may be arranged into one or more antenna panels. The antenna 526 may have antenna panels that are omnidirectional, directional, or a combination thereof to enable beamforming and multiple input, multiple output communications. The antenna 526 may include microstrip antennas, printed antennas fabricated on the surface of one or more printed circuit boards, patch antennas, or phased array antennas. The antenna 526 may have one or more panels designed for specific frequency bands including bands in FR1 or FR2.

The user interface 516 includes various input/output (I/O) devices designed to enable user interaction with the UE 500. The user interface 516 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 500.

The sensors 520 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 522 may include software and hardware elements that operate to control particular devices that are embedded in the UE 500, attached to the UE 500, or otherwise communicatively coupled with the UE 500. The driver circuitry 522 may include individual drivers allowing other components to interact with or control various input/output (I/O) devices that may be present within, or connected to, the UE 500. For example, driver circuitry 522 may include a display driver to control and allow access to a display device, a touchscreen driver to control and allow access to a touchscreen interface, sensor drivers to obtain sensor readings of sensors 520 and control and allow access to sensors 520, drivers to obtain actuator positions of electro-mechanic components or control and allow access to the electro-mechanic components, a camera driver to control and allow access to an embedded image capture device, audio drivers to control and allow access to one or more audio devices.

The PMIC 524 may manage power provided to various components of the UE 500. In particular, with respect to the processors 504, the PMIC 524 may control power-source selection, voltage scaling, battery charging, or DC-to-DC conversion.

A battery 528 may power the UE 500, although in some examples the UE 500 may be mounted deployed in a fixed location and may have a power supply coupled to an electrical grid. The battery 528 may be a lithium ion battery, a metal-air battery, such as a zinc-air battery, an aluminum-air battery, a lithium-air battery, and the like. In some implementations, such as in vehicle-based applications, the battery 528 may be a typical lead-acid automotive battery.

FIG. 6 illustrates a network device 600 in accordance with some embodiments. The network device 600 may be similar to and substantially interchangeable with base station 108 or a device of the core network 112 or external data network 120.

The network device 600 may include processors 604, RF interface circuitry 608 (if implemented as a base station), core network (CN) interface circuitry 614, memory/storage circuitry 612, and antenna structure 626.

The components of the network device 600 may be coupled with various other components over one or more interconnects 628.

The processors 604, RF interface circuitry 608, memory/storage circuitry 612 (including communication protocol stack 610), antenna structure 626, and interconnects 628 may be similar to like-named elements shown and described with respect to FIG. 5.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage circuitry 612 to cause the network device 600 to perform operations described herein. The processors 604 may also include interface circuitry 604D to communicatively couple the processor circuitry with one or more other components of the network device 600.

The CN interface circuitry 614 may provide connectivity to a core network, for example, a 5th Generation Core network (5GC) using a 5GC-compatible network interface protocol such as carrier Ethernet protocols, or some other suitable protocol. Network connectivity may be provided to/from the network device 600 via a fiber optic or wireless backhaul. The CN interface circuitry 614 may include one or more dedicated processors or FPGAs to communicate using one or more of the aforementioned protocols. In some implementations, the CN interface circuitry 614 may include multiple controllers to provide connectivity to other networks using the same or different protocols.

### Examples

Some further examples of various embodiments are provided below.

Example 1 includes a method comprising: setting a transmission power of a user equipment (UE) to a first value, the first value based on a target survival time associated with a communication session; and reducing the transmission power to a second value after expiration of the target survival time.

Example 2 includes the method of example 1, further comprising transmitting a signal with the first value of the transmission power and the second value of the transmission power to comply with a specific absorption rate (SAR) requirement.

Example 3 includes the method of example 1, wherein the first value of the transmission power is further based on one or more of a specific absorption rate (SAR) time window, an average power requirement over the SAR time window, an uplink duty cycle (ULDC), or the second value of the transmission power.

Example 4 includes the method of example 3, wherein the average power requirement is based on one or more of a radio access technology, a frequency band, an antenna port, or a location of the UE with respect to a user.

Example 5 includes the method of example 3, wherein the first value of the transmission power is further based on a maximum transmission power, and wherein the maximum transmission power is based on a regulation or hardware requirement.

Example 6 includes the method of example 1, wherein the target survival time is based on an expected uplink connection duration associated with the communication session.

Example 7 includes the method of example 6, wherein the expected uplink connection duration is based on an estimated duration of a radio resource control (RRC) connection and an estimated uplink duty cycle (ULDC) associated with the communication session.

Example 8 includes the method of example 1, wherein the target survival time is based on an application or a type of application associated with the communication session.

Example 9 includes the method of example 8, wherein the target survival time is based on historical data associated with the application or the type of application, wherein the historical data is further associated with the UE, a user of the UE, or other UEs.

Example 10 includes the method of example 1, wherein the target survival time is selected from among a plurality of candidate survival times.

Example 11 includes an apparatus comprising: processor circuitry to generate data associated with a communication session; and a radio frequency (RF) transmitter coupled to the processor circuitry, the RF transmitter to transmit the data with a first power level, the first power level based on a target survival time associated with the communication session; and transmit the data with a second power level after expiration of the target survival time, the second power level being less than the first power level.

Example 12 includes the apparatus of example 11, wherein the first power level is further based on a specific absorption rate (SAR) time window and an average power requirement over the SAR time window.

Example 13 includes the apparatus of example 11, wherein the first power level is based on an uplink duty cycle associated with the RF transmitter.

Example 14 includes the apparatus of example 11, wherein the target survival time is based on an expected uplink connection duration associated with the communication session.

Example 15 includes the apparatus of example 11, wherein the target survival time is based on an application or a type of application associated with the communication session.

Example 16 includes the apparatus of example 11, wherein the target survival time is based on historical information associated with the application or the type of application, and wherein the historical information is further associated with the UE, a user of the UE, or other UEs.

Example 17 includes one or more non-transitory, computer-readable media having instructions that, when executed, cause processor circuitry to: identify context information associated with a communication session over a wireless network; determine, based on the context information, a target survival time for a transmission power of a radio frequency (RF) transmitter; and set a value of the transmission power based on the target survival time.

Example 18 includes the one or more non-transitory, computer-readable media of example 17, wherein the context information includes one or more of an application to be used for the communication session, a type of application to be used for the communication session, location information associated with the communication session, or a time of day.

Example 19 includes the one or more non-transitory, computer-readable media of example 17, wherein the context information includes an estimated uplink connection duration associated with the communication session.

Example 20 includes the one or more non-transitory, computer-readable media of example 17, wherein the transmission power is set to a first value based on an uplink duty cycle (ULDC) of a user equipment (UE), and wherein the instructions, when executed, further cause the processor circuitry to reduce the transmission power to a second value after expiration of the target survival time.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A method comprising:
setting a transmission power of a user equipment (UE) to a first value, the first value based on a target survival time associated with a communication session; and
reducing the transmission power to a second value after expiration of the target survival time.

2. The method of claim 1, further comprising transmitting a signal with the first value of the transmission power and the second value of the transmission power to comply with a specific absorption rate (SAR) requirement.

3. The method of claim 1, wherein the first value of the transmission power is further based on one or more of a specific absorption rate (SAR) time window, an average power requirement over the SAR time window, an uplink duty cycle (ULDC), or the second value of the transmission power.

4. The method of claim 3, wherein the average power requirement is based on one or more of a radio access technology, a frequency band, an antenna port, or a location of the UE with respect to a user.

5. The method of claim 3, wherein the first value of the transmission power is further based on a maximum transmission power, and wherein the maximum transmission power is based on a regulation or hardware requirement.

6. The method of claim 1, wherein the target survival time is based on an expected uplink connection duration associated with the communication session.

7. The method of claim 6, wherein the expected uplink connection duration is based on an estimated duration of a radio resource control (RRC) connection and an estimated uplink duty cycle (ULDC) associated with the communication session.

8. The method of claim 1, wherein the target survival time is based on an application or a type of application associated with the communication session.

9. The method of claim 8, wherein the target survival time is based on historical data associated with the application or the type of application, wherein the historical data is further associated with the UE, a user of the UE, or other UEs.

10. The method of claim 1, wherein the target survival time is selected from among a plurality of candidate survival times.

11. An apparatus comprising:
processor circuitry to generate data associated with a communication session; and
a radio frequency (RF) transmitter coupled to the processor circuitry, the RF transmitter to transmit the data with a first power level, the first power level based on a target survival time associated with the communication session; and transmit the data with a second power level after expiration of the target survival time, the second power level being less than the first power level.

12. The apparatus of claim 11, wherein the first power level is further based on a specific absorption rate (SAR) time window and an average power requirement over the SAR time window.

13. The apparatus of claim 11, wherein the first power level is based on an uplink duty cycle associated with the RF transmitter.

14. The apparatus of claim 11, wherein the target survival time is based on an expected uplink connection duration associated with the communication session.

15. The apparatus of claim 11, wherein the target survival time is based on an application or a type of application associated with the communication session.

16. The apparatus of claim 11, wherein the target survival time is based on historical information associated with the application or the type of application, and wherein the historical information is further associated with the UE, a user of the UE, or other UEs.

17. One or more non-transitory, computer-readable media having instructions that, when executed, cause processor circuitry to:
identify context information associated with a communication session over a wireless network;
determine, based on the context information, a target survival time for a transmission power of a radio frequency (RF) transmitter; and
set a value of the transmission power based on the target survival time.

18. The one or more non-transitory, computer-readable media of claim 17, wherein the context information includes one or more of an application to be used for the communication session, a type of application to be used for the communication session, location information associated with the communication session, or a time of day.

19. The one or more non-transitory, computer-readable media of claim 17, wherein the context information includes an estimated uplink connection duration associated with the communication session.

20. The one or more non-transitory, computer-readable media of claim 17, wherein the transmission power is set to a first value based on an uplink duty cycle (ULDC) of a user equipment (UE), and wherein the instructions, when executed, further cause the processor circuitry to reduce the transmission power to a second value after expiration of the target survival time.
